(19) United States
(12) Patent Application Publication
(10) Pub. No.: US 2003/0033532 A1
(43) Pub. Date: Feb. 13, 2003

(54) System and method for forming an on-line buyer's club

(75) Inventor: James D. Marks, New York, NY (US)

Correspondence Address: DARBY & DARBY P.C., P. O. BOX 5257, NEW YORK, NY, 10150-5257, US

(73) Assignee: BODY HEALTH RESOURCES CORPORATION

(21) Appl. No.: 10/216,543

(22) Filed: Aug. 9, 2002

Related U.S. Application Data
(60) Provisional application No. 60/311,390, filed on Aug. 10, 2001.

(51) Int. Cl. H04L 9/00; G06F 17/60

(52) U.S. Cl. 713/182; 705/1

(57) ABSTRACT

A system and method for on-line formation of buyer's clubs, in particular, for the purchase of pharmaceutical goods, e.g., drugs, vitamins and/or herbs. Visitors of a web site are prompted while completing registration information whether to opt in to participate in a buyer's club. At least some of the registration information provided by those users that have chosen to opt in to participate in the buyer's club is transmitted to a Pharmaceutical Benefits Manager (PBM) and/or pharmacy that, in turn, enters into agreements with drug manufacturers to offer the pharmaceutical goods at discount prices. Member utilization information is generated by the PBM for each participant that purchases through the buyer's club. This member utilization information is transmitted from the PBM to the server. Additional information relating to or associated with the member utilization information is gathered and retrieved by the server and transmitted to user's computer terminal or accessible by the user upon visiting the web site. This targeted information may include, for example, new drug formulations, side effects of a particular drug purchased, and/or journal articles discussing the disease or ailment that the drug purchased is used to treat.

### RELATED APPLICATIONS

The present invention relates to, and claims priority of, U.S. Provisional Patent Application Serial No. 60/311,390 filed on Aug. 10, 2001, having the same title as the present invention, which is incorporated herein by reference.

### FIELD OF THE INVENTION

The present invention relates to the formation of a buyer's club to purchase goods and services at discounted prices and, in particular, to the formation of a virtual buyer's club over a network for the purchase of pharmaceutical goods.

### DESCRIPTION OF RELATED ART

The high cost of pharmaceutical goods, such as experimental drugs, prescription drugs, over the counter (OTC) drugs, herbs and vitamins have skyrocketed in recent years. This is particularly, detrimental for those individuals having no insurance or suffering from ailments that effect only a minority of the population. In some treatments, such as HIV/AIDS medications the annual costs for medications in the treatment of the disease can reach hundreds of thousands of dollars.

It would be beneficial to gather an-on-line database of individuals interested in participating in a buyer's club to purchase pharmaceutical goods.

### SUMMARY OF INVENTION

It is an object of the present invention to facilitate the on-line formation of buyer's clubs and obtain an on-line agreement for the release of medical and personal information by end users prior to opting in to the buyer's club. The agreement authorizes the release of the end user's medical and/or personal information.

The invention relates to a method for using a system for formation of an on-line pharmaceutical buyer's club. An end user's on-line consent is received over a network from a computer terminal to an electronic agreement to opt in to said buyer's club and to release of the end user's medical, personal information to an on-line pharmacy, to the on-line pharmacy's release of said end user's medical, personal information and personally identifiable prescription drug utilization data to the buyer's club, and to the receipt of targeted information whereby said end user becomes a member of said buyer's club.

In addition, this invention relates to receiving over a network from a computer terminal at least a portion of the member's medical and personal information. Then, determining whether the member has a medical trait based on said portion of the member's medical and personal information. Thereafter, supplying targeted information to the member if the member has the medical trait.

In addition, this invention relates to a method of receiving on-line consent from a plurality of end users. Then, determining a subset of end users who share a common medical trait based on said plurality of end user's medical and personal information. Then, receiving over a network from a computer terminal said subset of end user's on-line consent to an electronic agreement to opt in to said buyer's club whereby a buyer's club is formed that contains only members with said common medical trait.

In addition, the invention relates to a system forming an on-line buyer's club over a network including a secure server for generating an electronic agreement, and one or more computer terminals on which is displayed the electronic agreement. The computer terminal is used by an end user to provide their consent to the electronic agreement to opt-in to the buyer's club and release medical and/or personal data. In this configuration the server and computer terminals are connected via a network.

### BRIEF DESCRIPTION OF THE DRAWINGS

The foregoing and other features of the present invention will be more readily apparent from the following detailed description and drawing of an illustrative embodiment of the invention in which:

FIG. 1 is an exemplary high level diagram of the system for forming an on-line buyer's club for the purchase of prescription goods in accordance with the present invention;

FIG. 2 is an exemplary flow chart of the method for forming an on-line buyer's club for the purchase of prescription goods in accordance with the present invention;

FIG. 3 is an exemplary registration from display screen in accordance with the present invention; and

FIGS. 4a and 4b is an exemplary flow chart of the method for forming an on-line buyer's club for the purchase of prescription goods in accordance with the present invention.

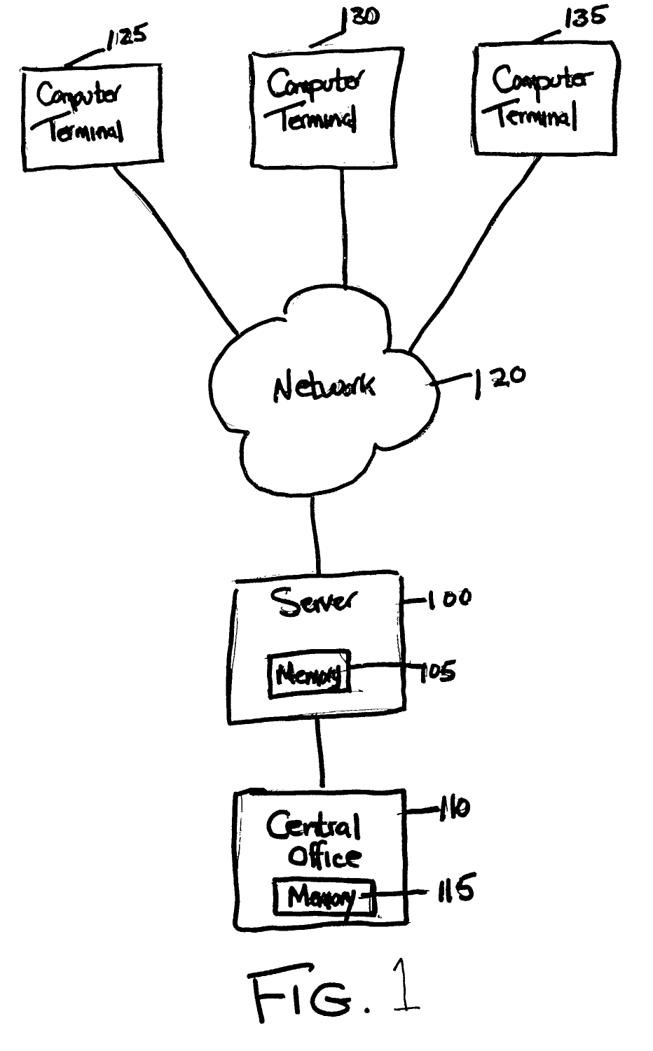

### DETAILED DESCRIPTION OF THE INVENTION

By way of example, the discussion of the system and method in accordance with the present invention is directed to on-line formation of buyer's clubs for the purchase of pharmaceutical goods in the treatment and prevention of HIV/AIDS. Such system and method is particularly advantageous for HIV/AIDS patients, as many do not have medical insurance and pay for their care out of pocket. Furthermore, many HIV/AIDS patients turn to self-care therapies. It should be noted, however, that the buyer's club may also be applicable to pharmaceutical goods for other diseases, ailments, disorders, and medical conditions.

The Figure shows an exemplary embodiment of a high-level diagram of a system or server 100 having a memory device 105. System 100 is connected to a central or main office 110 having a memory device 115. System 100 is accessed by multiple computer terminals 125, 130, 135 connected via a network 120, such as the Internet. While the system and method in accordance with the present invention is described in the context of the Internet or world wide web, it can also be used in other network environments, such as a local area network (LAN), Intranet, wide area network (WAN), or various wireless technology platforms, where the system and software are accessible by both subscribers and end users alike from remote locations. Only three computer terminals are shown, however, any number of computers may be connected to network 120 through known communication interfaces, such as an external or built-in modem (not shown). End users may access the system from any computer terminal throughout the world having appropriate network Internet access and software, such as a web browser. The system 100 uses a secure server, such as Netscape™, using secure socket layer (SSL) protocols or alternative security means. System 100 may be designed so that a user must employ a web browser that supports SSL. In a preferred embodiment, system 100 notifies the user if their web browser does not support SSL or if the particular version of the Internet access software installed by the end user falls below a minimum acceptable level of security functionality.

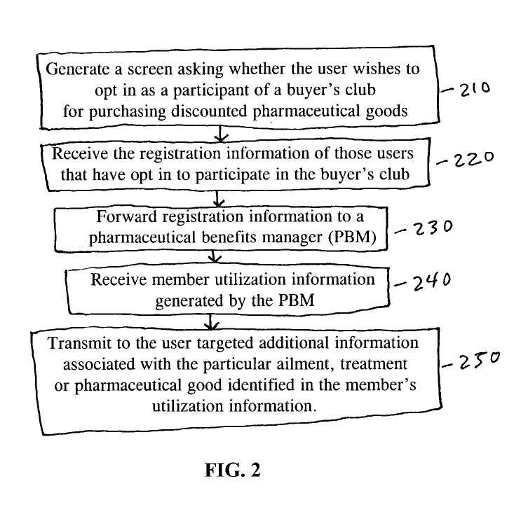

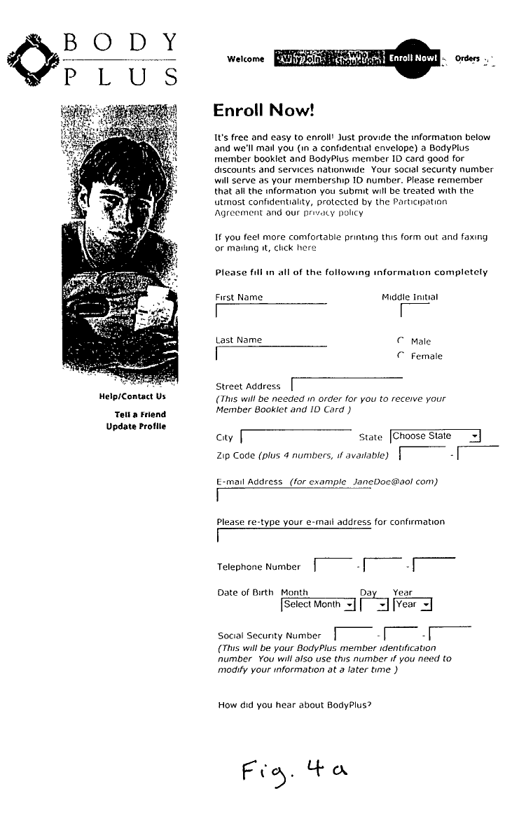

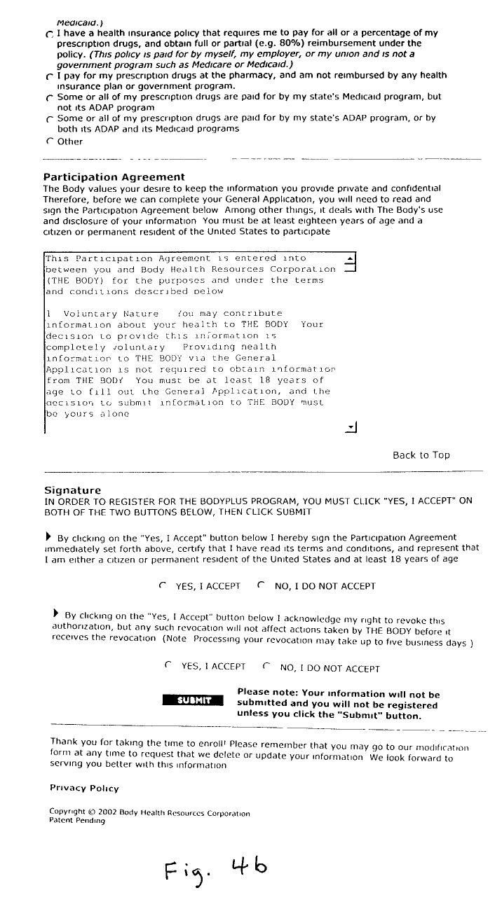

FIG. 2 is an exemplary flow chart of the method for on-line formation of buyer's clubs. In step 210, the user accesses the web site through the browser loaded on to their computer terminal 125, 130, 135 and a screen is generated asking whether the user wishes to opt in as a participant of a buyer's club for purchasing discounted pharmaceutical goods. In step 220, in an exemplary embodiment, acceptance to become a participant of the buyer's club may be part of a registration form for accessing the services of a particular web site. FIGS. 4a and 4b is an exemplary display screen showing a registration form. One such web site that lends itself to register participants in a buyer's club is a site that allows users to volunteer to be a participant in a clinical trial within a medical specialty, e.g., clinical trials in the prevention and/or treatment of HIV/AIDS.

Server 100 receives the registration information of those users that have opt in to participate in the buyer's club and stores the data in memory device 105. In step 230, at least some, if not all, of the registration information provided by the user is forwarded by the server 100 to the central or main office server 110. In a preferred embodiment, the central or main office server 110 may be associated with a Pharmaceutical Benefits Manager (PBM). PBMs often administer insurance-claim processing for drug benefits on behalf of private plans as a means to promote more cost-effective drug alternatives and also prevent the consumption of inappropriate drugs while encouraging consumption of needed ones. In addition, PBMs control the spiraling costs of drug-benefit programs by negotiating with pharmacies to set prescription prices, instituting mandatory generic substitution programs and negotiating volume purchase agreements with manufacturers. Typically PBMs develop a formulary, a list of selected non-generic drugs for which they provide full reimbursement and encourage the utilization of such drugs by offering them at reduced cost. Alternatively, the central or main office server 110 may be associated with a pharmacy that negotiates a volume discount price directly with the manufacturer on behalf of the participants of the buyer's club.

Initially PBMs were independent advocates for patients and employers beyond the scope of influence of larger pharmaceutical manufacturers. Recently attention has focused on PBMs as a result of several mergers of PBMs with large pharmaceutical companies thereby creating potential conflicts of interest. There is great concern in the medical industry that such mergers will result in removal competitors products being offered to consumer and that those PBMs owned by large drug manufacturers will be able to significantly underbid independently owned PBMs. Peer review by physicians and/or employers is one mechanism being employed to monitor and review PBM transactions. Even independently owned PBMs are limited in the pharmaceutical goods that they recommend and offer based on the agreements with the pharmaceutical manufacturers with whom they have transacted. Thus, the consumer is limited in the pharmaceutical goods offered for sale by the PBM.

The system and method in accordance with the present invention may be used to ensure that the patient receives more diverse information with which to make an informed selection of pharmaceutical goods. In step 240, member utilization information generated by the PBM with respect to the participant of the buyer's club is transmitted to the server 100. In step 250, this information is received by the server 100 and targeted additional information associated with the particular ailment, treatment or pharmaceutical good identified in the member's utilization information is gathered or retrieved to be transmitted to the user. The additional information can be any data associated with the member's utilization such as newer drugs offered by different manufacturers including links to related web sites. Other information to be provided may include a published report on the efficacy of that drug, a new drug therapy that has greater efficacy, possible side effects of the particular drug or any other information that in some way is associated or relevant to the member's utilization information. By way of example, the member's utilization data may reveal that the participant of the buyer's club is currently purchasing a certain medication for the treatment of HIV/AIDS. Server 100 upon receiving the utilization data can access additional information such as new drug therapies and that information is transmitted to the user (e.g., via e-mail to their computer terminal) or accessible by the user when visiting the web site.

By choosing to opt in to become a participant of the buyer's club the user will be entitled to purchase the pharmaceutical goods at a discounted price. Preferably, the purchase of the pharmaceutical goods may be conducted electronically from the web site.

When transmitting such personally identifiable medical data it is important to optimize security against any potential unwanted dissemination. Not only is the privacy of such data desirable from the point of view of the individual and their family, but legislation and regulations often mandate the level of security to be accorded personal and medical information. For example, the federal department of Health and Human Services has recently promulgated regulations concerning the level of security to be accorded transmission of medical records and personal data, and in particular New York legislation requires that prior to dissemination of medical information the individual sign a release form and that an opt out method be available when recruiting candidates for clinical trials. Other countries have recently adopted guidelines, such as the European Union data directive concerning procedural aspects of the dissemination of personal and medical information.

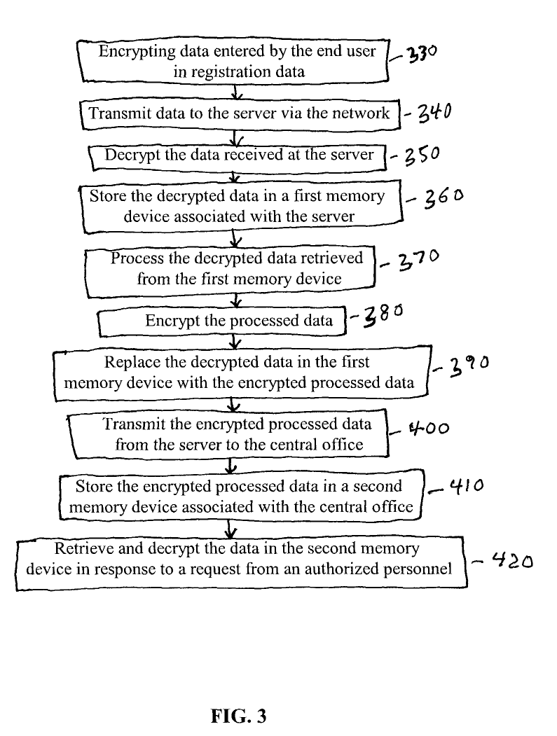

FIG. 3 is an exemplary embodiment of the system of securing data of the present invention. After the user has registered to opt in to participate in the buyer's club, in step 330, the personal and medical data entered is automatically encrypted by the user's web browser software installed in the computer terminal 125, 130, 135 before being transmitted to the server 100. Thus, any potential hackers attempting to intercept the confidential information during transmission between the user's computer terminal and the server 100 will be unable to decipher the data.

In step 340, encrypted data is transmitted between the user's computer terminal and the server 100 via network 120. In a preferred embodiment, transmission of information is not initiated until the user enters into some type of Consent Agreement. The user may access a digital certificate procured, for example, by Verisign™, to verify communication between the user's browser and server 100. Alternatively, a digital certificate may be automatically generated in response to the user completing the necessary information to register to participate in the buyers' club.

In steps 350-360, the encrypted responses received at the server 100 are decrypted and stored in memory device 105. The decrypted data stored in memory device 105 is subject to access by potential hackers who gain access to that server to observe the data while in its decipherable state. Server 100 circumvents this potential problem by implementing one or more precautionary measures. In particular, server 100 may be programmed to restrict access to the server to only a minimum number of trusted and screened employees. Security policies and procedures may be implemented to ensure that unauthorized personnel never access the decrypted information received by the server.

In steps 370-380, server 100 processes the registration data, preferably using a specification, such as Common Gateway Interface (CGI) “scripts”, to extend the service and capabilities of the web server, and automatically encrypts the processed data using Pretty Good Privacy (PGP) or some other known shareware encryption protocol. Thereafter, in step 290, Immediately after encryption, server 100 destroys or purges the unencrypted data stored in memory device 105, which, in turn, is replaced with the encrypted processed data. Encrypted processed data stored in memory device 105 is then transmitted from server 100 to the central of main office server 110 at the PBM and/or pharmacy, in step 400.

At the central or main office server 110 access to the user's data is restricted to limited personnel. In step 410, the user's registration data is stored in encrypted form in memory 115. Thereafter, in step 420, the data stored in memory 115 is retrieved and decrypted only when requested by authorized personnel. Encryption keys are preferably stored on an external memory device, such as a floppy disk, a compact disk, or some other storage device, and kept under surveillance, e.g., under lock and key, to which only authorized employees have access.

It is desirable to develop a comprehensive security system. Accordingly, additional safeguards are contemplated and within the intended scope of the invention including the use of firewalls or other known security measures.

In addition to ensuring that information remain secure during transmission it is also important to provide a feature or mechanism by which a previously registered participant of the buyer's club may subsequently choose to opt out. At any point in time a participant of the buyer's club may opt-out by removing their name from the database of registered participants. By way of example, the volunteer is preferably asked to enter their first name, last name, and date of birth. Any information may be requested so long as the particular participant to be removed can be properly identified. Additional information may be used to properly identify the participant, such as the maiden name of the volunteer's mother. It is contemplated that the most basic information, e.g., the full name and date of birth of the volunteer, may be initially requested and that additional information will be solicited only if the database identifies multiple matches from the database of registered participants. In an alternative embodiment, the participant when registering with the service is assigned a unique identification number that may be subsequently entered when requesting to be removed from the list of registered participants. In this alternative embodiment, if the participant could not recall their identification number, other means of identification, as discussed above, may be employed.

PBMs and/or pharmacies interested in accessing the database of participants of the buyer's club register with the central office 110. The registration process may be performed on-line by accessing the web site or via some other communication medium, such as by filling out a printed registration form. The completed registration form is forwarded to the server 100. In a preferred embodiment of the invention, the server verifies the credentials and legitimacy of the PBM and/or pharmacy before establishing an affiliation. Once initial approval is provided, a representative of the PBM and/or pharmacy must enter into an agreement to be bound by the rules concerning the prevention against unwanted dissemination of the personal and medical records of registered participants of the buyer's club.

A fee is tabulated by server 100, for example, a percentage of the consumer's spending or a fixed transactional fee. In a preferred embodiment, the fee is accounted for by reducing the discount to the consumer by an appropriate amount. Alternatively, or in addition thereto, a fee for the services provided in operation of the web site may be realized by deriving revenue directly from the pharmaceutical manufacturer. When the participants of the buyer's club are obtained from a comprehensive national program directed to a medical specialty, it is desirable for the drug companies to generate educational materials about the drugs manufactured by that company to be disseminated as part of the additional information sent from the server 100 to the participant of the buyer's club. Accordingly, revenue may be generated by assessing a fee to distribute this additional information to the consumer.

It is also within the intended scope of the present invention for the physician to prescribe a particular drug and submit the prescription electronically directly to the PBM or pharmacy. The participant of the buyer's club receives the prescribed drug without having to make a separate submission or go to the pharmacy. Additional information, triggered by the filling of the prescription, may automatically be sent to the consumer, e.g., electronically via e-mail. This information, for example, may include prescribing information (when and with what liquids the drug is to be taken, possible side effects or contraindications, etc.) that may be far more detailed than the pamphlet or insert that typically accompanies the prescribed drug.

Generally, the discount in the cost of the pharmaceutical goods is proportional to the size of the membership of registered participants of the buyer's club and/or overall cost of the pharmaceutical goods being purchased. That is, the larger the membership and/or higher the cost of the pharmaceutical goods being purchased, the greater the discount in the cost. Accordingly, it is advantageous to combine the system and method in accordance with the present invention with existing services directed to a concentrated or specific medical condition offered at a single web site. One such web site is that of an interactive question and answer web site directed to disseminating information related to a specific medical condition. Another web site is may offer a means for volunteering to participate in clinical trials concerning a specific medical condition. As part of the registration process the user may be asked whether they wish to opt in to participate in a buyer's club.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1. A method for using a system for formation of an on-line pharmaceutical buyer's club comprising the step of:
receiving over a network from a computer terminal an end user's on-line consent to an electronic agreement to opt in to said buyer's club and to release of the end user's medical, personal information to an on-line pharmacy, to the pharmacy's release of said end user's medical, personal information and personally identifiable prescription drug utilization information to the buyer's club whereby said end user becomes a member of said buyer's club.

2. A method in accordance with claim 1, further comprising receiving on-line consent to the receipt of targeted information.

3. A method in accordance with claim 2, wherein the step of receiving on-line consent to opt in further comprises receiving over a network from a computer terminal an end user's registration for access to a web site, wherein said registration includes registration data, and wherein said registration data includes medical and personal information.

4. A method in accordance with claim 1, wherein said website is a website that permits the user's medical, personal, and personally identifiable prescription drug utilization data to be evaluated by researchers in order to be included in a clinical trial.

5. A method in accordance with claim 3, further comprising receiving over a network from a computer terminal the member's request to purchase at least one prescription drug.

6. A method in accordance with claim 5, further comprising transmitting at least a portion of said registration data to a central office.

7. A method in accordance with claim 6, wherein said central office is operated by an seller of prescription pharmaceuticals.

8. A method in accordance with claim 7, further comprising receiving said member's personally identifiable prescription drug utilization information over a network from said central office.

9. A method in accordance with claim 8, further comprising supplying targeted information to a selected member, wherein the member is selected based on the member's personally identifiable prescription drug utilization information.

10. A method in accordance with claim 5, further comprising supplying targeted information to a selected member, wherein the member is selected based on the member's registration data.

11. A method in accordance with claim 5 further comprising supplying targeted information to a selected member, wherein the member is selected based on the member's medical condition, and wherein said medical condition is determined based on said registration data.

12. A method in accordance with claim 8, further comprising supplying targeted information to a selected member, wherein the member is selected based on at least one drug used by said member, and wherein said at least one drug is determined based on the member's personally identifiable prescription drug utilization information.

13. A method in accordance with claim 5, further comprising providing a discount price on said prescription drug.

14. A method in accordance with claim 7, further comprising establishing an affiliation with said seller of prescription pharmaceuticals prior to transmitting said at least a portion of said registration data to said central office.

15. A method in accordance with claim 14, wherein said establishing an affiliation with said pharmaceutical benefits manager further comprises verifying the credentials and legitimacy of said seller of prescription pharmaceuticals.

16. A method in accordance with claim 7, wherein said seller of prescription pharmaceuticals is pharmaceutical benefits manager.

17. A method in accordance with claim 7, wherein said seller of prescription pharmaceuticals is a pharmacy.

18. A method in accordance with claim 14, wherein said establishing an affiliation with said pharmaceutical benefits manager further comprises entering into an agreement with the seller of prescription pharmaceuticals to maintain the privacy of said membership utilization information.

19. A method in accordance with one of claim 1, further comprising encrypting said registration data and/or said member utilization data;
transmitting the encrypted data to a secure server via the network;
decrypting the data received at said secure server;
storing the decrypted data in a first memory device associated with said secure server;
processing the decrypted data retrieved from the first memory device;
encrypting the processed data;
replacing the decrypted data in the first memory device with the encrypted processed data;
transmitting the encrypted processed data from said secure server to a central office; and
storing the encrypted processed data in a second memory device associated with said central office.

20. A method in accordance with claim 19, further comprising the steps of:
in response to a request from an authorized individual, retrieving the encrypted processed data from the second memory device; and
decrypting the retrieved encrypted processed data from the second memory device.

21. A method in accordance with claim 19, further comprising ensuring that decrypted data stored at said secure server is not accessed by unauthorized personnel.

22. A method in accordance with claim 21, wherein said ensuring step comprises at least one of limiting access to said secure server to a minimum number of authorized personnel, identifying as authorized personnel only trustworthy employees, and devising and implementing procedures to ensure that only authorized personnel gain access to the decrypted data.

23. A method in accordance with claim 8, further comprising generating using said secure server an electronic opt-out form to be displayed on the computer terminal to remove any consent received in said electronic agreement to opt in at any time subsequent to receiving the member's consent.

24. A method in accordance with claim 8, wherein the electronic agreement satisfies all federal, state, and local rules, ordinances and regulations.

25. A method for using a system for formation of a pharmaceutical buyer's club comprising the step of:
receiving over a network from a computer terminal an end user's on-line consent to an electronic agreement to opt in to said buyer's club and to the release of said an end user's medical and personal information to an pharmacy, to the pharmacy's release of said end user's medical, personal, and personally identifiable prescription drug utilization information to the buyer's club and to the receipt of targeted information whereby said end user becomes a member of said buyer's club;
receiving over a network from a computer terminal at least a portion of the member's medical and personal information;
determining whether the member has a medical trait based on said portion of the member's medical and personal information; and
supplying targeted information to the member if the member has the medical trait.

26. A method for using a system for formation of a pharmaceutical buyer's club comprising the step of:
receiving over a network from a computer terminal a plurality of end users' online consent to an electronic agreement to opt in to said buyer's club and the release of said an end users' medical and personal information to an pharmacy and to the pharmacy's release of said end users' medical and personal information and personally identifiable prescription drug utilization data to the buyer's club;
wherein the step of receiving on-line consent to release medical and personal information in further comprises receiving over a network from a computer terminal an end user's registration for access to a web site, wherein said registration includes registration data, and wherein said registration data includes medical and personal information;
determining a subset of end users who share a common medical trait based on said plurality of end user's medical and personal information;
receiving over a network from a computer terminal said subset of end users' online consent to an electronic agreement to opt in to said buyer's club whereby a buyer's club is formed that contains only members with said common medical trait.

27. A method in accordance with claim 26, wherein said medical trait is an illness.

28. A method in accordance with claim 27, wherein said medical trait is the use of a particular drug.

29. A system for formation of a pharmaceutical buyer's club over a network comprising:
a secure server generating an electronic agreement, and
at least one computer terminal on which is displayed the electronic agreement, said at least one computer terminal used by an end user to provide consent to said electronic agreement to opt in to said buyer's club and to the release of said an end user's medical and personal information to an on-line pharmacy and to the on-line pharmacy's release of said end user's medical, personal and personally identifiable drug utilization information to said buyer's club and to the receipt of targeted information whereby said end user becomes a member of said buyer's club, said secure server and said at least one computer terminal being connected via the network.

30. A system in accordance with claim 29, wherein a registration form is displayed on said at least one computer and wherein at least one computer is used by said end user to further provide said end user registration for access to a web site, wherein said registration includes registration data, and wherein said registration data includes medical and personal information.

31. A system in accordance with claim 29, wherein a request form is displayed to the member on said at least one computer and wherein said at least one computer processes the member's request to purchase at least one prescription drug.

32. A system in accordance with claim 31, further comprising a central office, and wherein said secure server is configured to transmit at least a portion of said registration data to said central office.

33. A system in accordance with claim 32, wherein said central office is operated by an seller of prescription pharmaceuticals.

34. A system in accordance with claim 33, wherein said central office is configured to transmit the member's personally identifiable prescription drug utilization data over a network to said secure server.

35. A system in accordance with claim 34, wherein said secure server is configured to determine whether a member of the buyer's club has a medical trait whereby the member of the buyer's club becomes a selected member and transmit targeted information related to the medical trait to the selected member if the selected member has said medical trait.

36. A system in accordance with claim 35, wherein said determination is based on said registration data.

37. A system in accordance with claim 35, wherein said determination is based on said the member's personally identifiable prescription drug utilization data.

38. A system in accordance with claim 35, wherein said medical trait is said member's medical condition.

39. A system in accordance with claim 35, wherein said medical trait is at least one drug used by said end user.

40. A system in accordance with claim 34, wherein said seller of prescription pharmaceuticals provides a discount on said prescription drug to said member based on said end users membership in said buyer's club.

41. A system in accordance with claim 33, wherein said website establishes an affiliation with said seller of prescription pharmaceuticals prior to transmitting said at least a portion of said registration data to said central office.

42. A system in accordance with claim 41, wherein said establishment of an affiliation with said pharmaceutical benefits manager further comprises verifying the credentials and legitimacy of said seller of prescription pharmaceuticals.

43. A system in accordance with claim 33, wherein said seller of prescription pharmaceuticals is pharmaceutical benefits manager.

44. A system in accordance with claim 33, wherein said seller of prescription pharmaceuticals is a pharmacy.

45. A system in accordance with claim 41, wherein said establishment of an affiliation with said pharmaceutical benefits manager further comprises entering into an agreement with the seller of prescription pharmaceuticals to maintain the privacy of said membership utilization information.

46. A system in accordance with one of claims 33, wherein said at least one computer terminal includes web browser software for encrypting said registration data entered at said at least one computer terminal;
wherein said encrypted registration data is received by said secure server via the network;
wherein said secure server decrypts the encrypted registration data;
wherein said secure server includes a first memory device for storing the decrypted registration data;
wherein said secure server includes processes the decrypted registration data;
wherein said secure server encrypts the processed data;
wherein the secure server replaces the decrypted data in the first memory device with the encrypted processed data;
wherein said secure server transmits the encrypted processed data to a central office; and;
said secure server stores the encrypted processed data in a second memory device associated with said central office.

47. A system according to claim 46, wherein said secure server and said central office are the same device at the same location.

48. A system in accordance with claim 47, wherein said central office, in response to a request from an authorized individual, retrieves the encrypted processed data from the second memory device; and
decrypts the retrieved encrypted processed data from the second memory device.

49. A system in accordance with claim 46, said secure server ensures that decrypted data stored at said secure server is not accessed by unauthorized personnel by at least one of limiting access to said secure server to a minimum number of authorized personnel, identifying as authorized personnel only trustworthy employees, and devising and implementing procedures to ensure that only authorized personnel gain access to the decrypted data.

50. A system in accordance with claim 29, wherein said secure server generates an electronic opt-out form to be displayed on the computer terminal to remove any consent received in said electronic agreement to opt in at any time subsequent to receiving the member's consent.

51. A system in accordance with claim 29, wherein the electronic agreement satisfies all federal, state, and local rules, ordinances and regulations.
